(19) United States
(12) Patent Application Publication
(10) Pub. No.: US 2013/0037402 A1
(43) Pub. Date: Feb. 14, 2013

(54) Apparatus for Recovery of Organic Compounds and Drying of Organic Mass

(71) Applicants: Antti Pasanen, Espoo (FI); Mikko Ahokas, Helsinki (FI); Reetta Niemi-Korpi, Vantaa (FI)

(72) Inventors: Antti Pasanen, Espoo (FI); Mikko Ahokas, Helsinki (FI); Reetta Niemi-Korpi, Vantaa (FI)

(73) Assignee: ST1 BIOFUELS OY, Helsinki (FI)

(21) Appl. No.: 13/511,617

(22) PCT Filed: Nov. 23, 2010
(86) PCT No.: PCT/FI2010/050955

§ 371 Date: Nov. 1, 2012

(30) Foreign Application Priority Data
Nov. 24, 2009 (FI) 20096239

(51) Int. Cl. B01D 3/14

(52) U.S. Cl. 202/159

(57) ABSTRACT

The invention relates to an apparatus for recovery of organic compounds and drying organic mass. The apparatus comprises a dryer incorporating a dryer vessel equipped with a material inlet nozzle, a material outlet nozzle and a gas discharge nozzle. The apparatus comprises a column communicating with the gas discharge nozzle of the dryer vessel for feeding discharge gas exiting via the gas discharge nozzle of the dryer vessel to the column in order to concentrate in the column the discharge gas or the portion of the discharge gas at least partially condensed. To the gas discharge nozzle is connected a boiler for transferring the thermal energy of the discharge gas flowing through the gas discharge nozzle at least partially to the column.

### BACKGROUND OF INVENTION

The invention relates to an apparatus in accordance with the preamble of claim 1 for recovery of organic compounds and drying of organic mass.

The apparatus disclosed in the invention is particularly suited for continuous or batchwise recovery of highly volatile organic compounds and drying organic mass.

The most crucial problem in the recovery of volatile organic compounds from a solid mass is related to the low thermal conductivity of a solid mass and the easily inflammable compounds contained therein.

While possibly operating at an extremely high specific energy consumption, dryers using direct heating by steam may have a high efficiency. Also in the art are known hot-air blowers operating with the risk that their hot air in combination with easily flammable organic compounds such as ethanol can form an explosive mixture. Further known is an SHS dryer that can be advantageously used for drying.

### BRIEF SUMMARY OF THE INVENTION

Now a method has been invented that is extremely efficient and safe in use at a low specific energy consumption.

To the end of achieving its goal, the invention is characterized by the features disclosed in the appended independent claims.

The other claims describe other preferred embodiments of the invention.

In the apparatus according to the invention, the gas outlet nozzle of the dryer apparatus, advantageously similar to that of a prior-art dryer apparatus disclosed in patent publication PCT/FI2005/050300, is connected to a boiler and routed therefrom to a concentrating and/or stripping column. The condenser of the distillation column may have a vacuum pump connected thereto.

The dryer according to the invention may use the bottom product of the stripping column for preheating the organic mass.

The method described herein offers extremely efficient energy utilization as the distillation column disposes with the need for supplementary energy, e.g., for bioethanol concentration.

According to a preferred embodiment of the invention, the apparatus is essentially gas-tight.

According to a preferred embodiment of the invention, the dryer incorporates one or more dryer vessels for final drying of the discharged organic mass.

The invention may advantageously use mechanical recompression.

According to a preferred embodiment of the invention, the dryers are connected in such a fashion that the surplus energy of the first-stage dryer can be utilized in the subsequent stage with the help of mechanical steam recompression.

According to a preferred embodiment of the invention, the method is employed for recovery of highly volatile compounds from difficult-to-process organic or inorganic masses, such as mash resulting from ethanol production. Generally, these masses are difficult to pump. Organic masses falling in this category may comprise fermented organic masses, as well as fermented waste containing highly volatile compounds such as ethanol, methanol, carbon dioxide, organic acids or sulfur.

### BRIEF DESCRIPTION OF THE DRAWINGS

Next some preferred exemplary embodiments of the invention are described in more detail by way of making reference to the appended drawings in which

FIG. 1 shows a single-stage dryer and a concentrating and/or stripping column and

FIG. 2 shows a two-stage MVR dryer and a concentrating and/or stripping column.

### DETAILED DESCRIPTION OF THE INVENTION

The invention relates to an apparatus for recovery of organic compounds such as water-containing organic compounds and drying organic mass.

The apparatus comprises a dryer 13 incorporating a dryer vessel 1 with a material inlet nozzle 10, a material outlet nozzle 11 and a gas discharge nozzle 2.

Dryer 13 comprises advantageously, but not necessarily, means for mixing the mass being dried during drying. It is further possible that dryer 13 incorporates a rotatable unit similar to a drum dryer (not shown in the diagrams) for mixing the mass being dried during the drying process.

The apparatus comprises a column 4 communicating with the gas discharge nozzle 2 of the dryer vessel 1 for feeding discharge gas 14 exiting via the gas discharge nozzle 2 of the dryer vessel 1 to column 4 for concentrating the discharge gas 14 contained in column 4. The function of column 4 may be, e.g., to strip by evaporation the discharge gas 14 free from, e.g., water and other components having even higher volatility, such as ethanol.

To the gas discharge nozzle 2 is connected a boiler 3 for transferring the thermal energy of the discharge gas 14 flowing through the gas discharge nozzle 2 at least partially to column 4 prior to feeding the discharge gas 14 to column 4.

The boiler incorporates advantageously but not necessarily a heat exchanger for transferring the thermal energy of the discharge gas 14 flowing through the heat exchanger to the portion of discharge gas 14 contained in column 4 or to the discharge gas 14 that has at least partially been condensed in the column.

The column 4 is advantageously but not necessarily a distillation and/or stripping column.

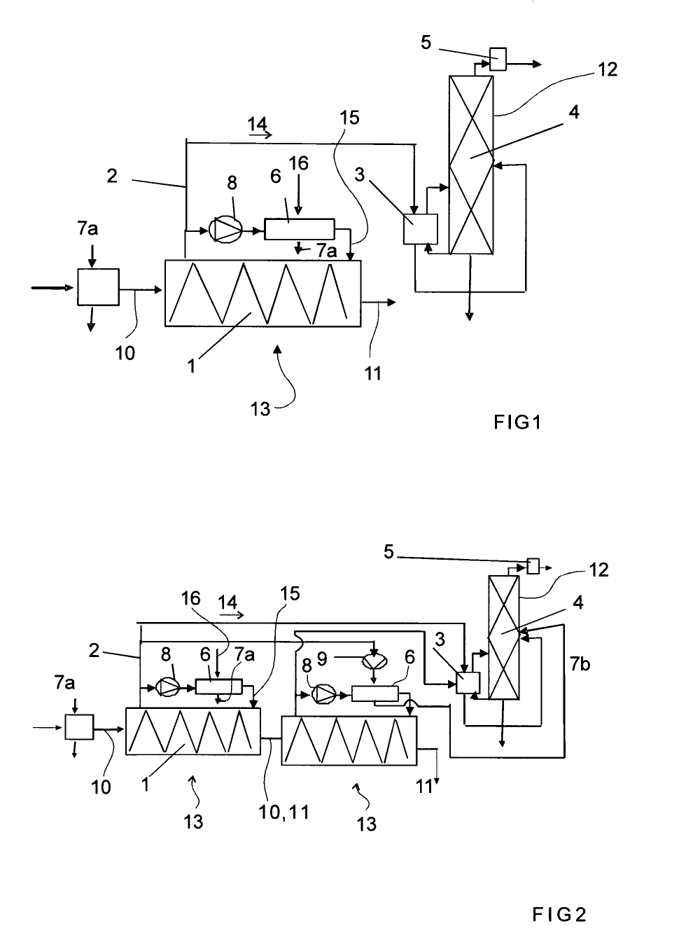

The dryer vessel 1 includes a gas inlet nozzle 15. In FIG. 1 the gas discharge nozzle is of the dryer vessel 1 is shown communicating with the gas inlet nozzle 15 of the dryer vessel in such an arrangement that between the gas outlet nozzle and the gas inlet nozzle 15 is adapted a fan 8 for circulating discharge gas 14 back to the dryer vessel as a circulating gas. As further shown in FIG. 1, between the gas outlet nozzle 2 and the gas inlet nozzle 15 is adapted a superheater 6 for elevating the temperature of the circulating gas. The apparatus may comprise an arrangement 7a, 7b for utilizing the condensate created in the superheater for predrying the material being fed into the dryer vessel.

The dryer 13 is advantageously but not necessarily essentially gas-tight in such a fashion that, e.g., the only outlet of the gas contained in the dryer is the gas outlet nozzle 2.

As shown in FIG. 2, the apparatus may incorporate a plurality of dryers 13 connected in series in such a fashion that the material outlet nozzle 11 of one upstream dryer 13 is connected to the material inlet nozzle 10 of another dryer 13 downstream in the process and/or acts as the material inlet nozzle 10 of the other dryer.

In the case that the apparatus comprises a plurality of dryers, advantageously but not necessarily the apparatus comprises a fan 9 is incorporated for transferring the discharge gas 14 of the upstream dryer 13 to the downstream dryer 13. For instance, it is possible that the gas discharge nozzle 2 of the upstream dryer 13 is adapted to communicate with the gas inlet nozzle 15 of the downstream dryer 13. A further possible arrangement is such that the downstream dryer 13 incorporates a gas discharge nozzle communicating with the gas discharge nozzle 15 of said downstream dryer 13 for recirculating the discharge gas 14 back to said downstream dryer vessel 1 and that between the gas discharge nozzle of the downstream dryer 13 and the gas discharge nozzle 15 is adapted a fan 8 and a superheater 6 and that the gas discharge nozzle 2 of the upstream dryer 13 communicates with the superheater 6. Fan 9 is advantageously but not necessarily adapted to elevate the pressure of discharge gas 14.

As shown in the diagrams, column 4 incorporates a condenser 12 having a vacuum pump 5 connected thereto for generating a vacuum at the gas discharge nozzle 2 via the condenser 12. The vacuum level of the discharge gas 14 is advantageously but not necessarily in the range of 100-800 mbar.

In FIG. 1 is shown an apparatus comprising a dryer vessel 1 having a gas discharge nozzle 2. To the gas discharge nozzle is connected a boiler 3. The boiler serves as boiler vessel for the concentration and/or stripping column 4. To the condenser of the concentration and/or stripping column is connected a vacuum pump 5. Energy infeed is advantageously accomplished by feeding steam, particularly superheated steam, or hot oil 16 to the superheater 6. In a conventional fashion the saturated steam circulated with the help of fan 8. The excess energy of the superheater can be utilized in preheating stage 7a for preheating the material being fed to dryer vessel 1.

In FIG. 2 is illustrated an apparatus layout having two dryers of the type shown in FIG. 1 connected in series in such a way that the gas discharge nozzle 2 of the first dryer is connected to the superheater 6 of the second dryer. Fan 9 is connected to the gas discharge nozzle. In the fashion shown in FIG. 2 the excess energy of superheater 6 of the upstream dryer 13 is utilized in preheater stage 7a for preheating the material being fed into dryer vessel 1 and the excess energy of the superheater 6 of downstream dryer 13 is employed in column 4 by way of feeding condensate 7b into column 4.

### EXAMPLE

Next is described an exemplary embodiment of process parameters for a recovery process of a volatile compound such as ethanol from an organic mass received as fermented biowaste:
fermented biowaste, dry solids content 20%, EtOH content 2%, temperature in dryer 200° C., infeed material 2000 kg/h,
evaporated mass 1400 kg/h,
recovery of concentrated ethanol 400 kg/h,
superheated steam (pressure 15 bar),
dryer vessel pressure 800 mbar,
distillation column pressure 400 mbar,
dried biowaste (dry solids content 60%) 600 kg/h,
steam consumption 800 kg/h.

To a person skilled in the art it is obvious that the spirit of the invention may be implemented in a plurality of different ways along developments in the state of the art. Hence, the invention and its implementations are not limited by the above-described exemplary embodiments, but rather may be varied within the inventive spirit and scope of the appended claims.

1-14. (canceled)

15. An apparatus for recovery of organic compounds and drying organic mass, the apparatus comprising
a dryer incorporating a dryer vessel equipped with a material inlet nozzle, a material outlet nozzle and a gas discharge nozzle;
a column communicating with the gas discharge nozzle of the dryer vessel for feeding discharge gas exiting via the gas discharge nozzle of the dryer vessel to the column in order to concentrate in the column the discharge gas or the portion of the discharge gas at least partially condensed; and
a boiler connected to the gas discharge nozzle, the boiler for transferring the thermal energy of the discharge gas flowing through the gas discharge nozzle at least partially to the column.

16. The apparatus of claim 15, wherein said boiler incorporates a heat exchanger for transferring the thermal energy of the discharge gas flowing through the heat exchanger to the portion of discharge gas contained in the column or to the discharge gas in the column that gas has at least partially been condensed.

17. The apparatus of claim 15, wherein said column is a distillation and/or stripping column.

18. The apparatus of claim 15, wherein
the dryer vessel incorporates a gas inlet nozzle and
the gas outlet nozzle of the dryer vessel communicates with the gas inlet nozzle of the dryer vessel in such a fashion that between the gas outlet nozzle and the gas inlet nozzle is adapted a fan for recirculating the discharge gas back to the downstream dryer vessel as recirculating gas.

19. The apparatus of claim 18, wherein between the gas outlet nozzle and the gas inlet nozzle is adapted a superheater for elevating the temperature of the recirculating gas.

20. The apparatus of claim 19, wherein the apparatus comprises an arrangement for utilizing the condensate created in the superheater for predrying the material being fed into the dryer vessel.

21. The apparatus of claim 15, wherein the dryer is essentially gas-tight.

22. The apparatus of claim 15, wherein the apparatus incorporates a plurality of dryers connected in series in such a fashion that the material outlet nozzle of one dryer is connected to the material inlet nozzle of another dryer and/or acts as the material inlet nozzle of the other dryer.

23. The apparatus of claim 22, wherein the apparatus incorporates a fan for transferring the discharge gas of the upstream dryer to the downstream dryer.

24. The apparatus of claim 23, wherein the gas outlet nozzle of the upstream dryer communicates with the gas inlet nozzle of the downstream dryer.

25. The apparatus of claim 24, wherein
the downstream dryer incorporates a gas discharge nozzle communicating with the gas discharge nozzle of said downstream dryer for recirculating the discharge gas back to said downstream dryer vessel;
between the gas discharge nozzle of the downstream dryer and the gas discharge nozzle is adapted a fan and a superheater; and
the gas discharge nozzle of the upstream dryer communicates with the superheater.

26. The apparatus of claim 23, wherein the fan is adapted to elevate the pressure of discharge gas.

27. The apparatus of claim 15, wherein the column incorporates a condenser having a vacuum pump connected thereto for generating a vacuum at the gas discharge nozzle via the condenser.

28. The apparatus of claim 27, wherein the vacuum level of the discharge gas is in the range of 100-800 mbar.
